(19) United States
(12) Patent Application Publication
(10) Pub. No.: US 2026/0301272 A1
(43) Pub. Date: Oct. 1, 2026

(54) STATEFUL BRANCHING AND MULTI-VARIANT GENERATION FOR CONVERSATIONAL MEDIA CREATION

(71) Applicant: Dorian Cartwright, San Jose, CA (US)

(72) Inventor: Dorian Cartwright, San Jose, CA (US)

(21) Appl. No.: 19/696,219

(22) Filed: Jun. 2, 2026

Related U.S. Application Data
(63) Continuation-in-part of application No. 19/667,591, filed on May 4, 2026.
(63) Continuation-in-part of application No. 19/664,886, filed on Apr. 30, 2026.
(63) Continuation-in-part of application No. 19/658,054, filed on Apr. 24, 2026.
(63) Continuation-in-part of application No. 19/630,125, filed on Mar. 26, 2026.
(60) Provisional application No. 63/970,881, filed on Jan. 29, 2026.
(60) Provisional application No. 63/978,933, filed on Feb. 9, 2026.
(60) Provisional application No. 64/002,939, filed on Mar. 11, 2026.

(51) Int. Cl. G06T 11/60; G06N 3/0475

(52) U.S. Cl. CPC G06T 11/60; G06N 3/0475

(57) ABSTRACT

A generative media system executes a parent media trajectory while maintaining a live generative state associated with generation of a video, image sequence, animation, effect, style transformation, or other temporally evolving media output. During execution, a branch instruction identifying a fork point and a modified prompt or parameter set is received, including from a conversational artificial intelligence assistant. Without halting the parent trajectory, the system derives a child generative state from the live generative state by snapshotting, referencing, checkpointing, or copy-on-writing at least a portion of the live generative state. The parent trajectory continues using the live generative state while one or more child trajectories execute using corresponding child generative states and modified prompts or parameters. Branch metadata links the parent and child trajectories in a media project lineage graph. Candidate outputs may be compared, selected, merged, discarded, or exported, thereby enabling non-blocking mid-flight branching and shared-state multi-variant generation without restarting each media generation from an initial state.

### CROSS-REFERENCE TO RELATED APPLICATIONS

This application claims priority as a continuation-in-part, under 35 USC 120, to U.S. patent application Ser. No. 19/630,125, filed Mar. 26, 2026, entitled AUTONOMOUS ARTIFICIAL INTELLIGENCE (AI) AGENT CONTROL OF MULTITIER AI INFERENCE DISAGGREGATION, by Dorian Cartwright, the entire contents of which are incorporated herein by reference.

This application claims priority as a continuation-in-part, under 35 USC 120, to U.S. patent application Ser. No. 19/658,054, filed Apr. 24, 2026, entitled DYNAMIC MEMORY REMAPPING FOR MANIFOLD-CONSTRAINED RESIDUAL LANES IN NEURAL NETWORK SYSTEMS, by Dorian Cartwright, the entire contents of which are incorporated herein by reference.

This application claims priority as a continuation-in-part, under 35 USC 120, to U.S. patent application Ser. No. 19/664,886, entitled DYNAMIC EXECUTION BRANCHING FOR IN-FLIGHT GENERATIVE VIDEO INFERENCE IN A NEURAL PROCESSING UNIT, by Dorian Cartwright, the entire contents of which are incorporated herein by reference.

This application claims priority as a continuation-in-part, under 35 USC 120, to U.S. patent application Ser. No. 19/667,591, filed May 4, 2026, entitled KV CACHE-BACKED USER-SELECTABLE CONTINUATION BRANCHES FOR ARTIFICIAL INTELLIGENCE (AI) INFERENCE, by Dorian Cartwright, the entire contents of which are incorporated herein by reference.

This application claims priority under 35 USC 119(e), to applicant's prior U.S. Provisional Patent Application No. 64/002,939, filed Mar. 11, 2026, entitled MULTIDIMENSIONAL PARALLEL TRAINING PIPELINE FOR MACHINE LEARNING MODEL, by Dorian Cartwright, the entire contents of which are incorporated herein by reference.

### FIELD OF THE INVENTION

The present disclosure relates generally to computers and artificial intelligence, and more specifically, to non-blocking duplication or referencing of live generative media state to spawn child trajectories with modified prompts or parameters while a parent generative media trajectory continues execution.

### BACKGROUND

Generative media systems can produce videos, images, animations, effects, avatars, simulations, augmented-reality scenes, and other temporally evolving media outputs. A user may initiate a generation process with a prompt, style instruction, source video, timeline, or media asset. During generation, the user may wish to explore alternatives, such as a different color grade, music style, aspect ratio, character motion, caption style, background, or ending.

Conventional systems often handle such alternatives by starting separate generation jobs from the beginning, duplicating a project after completion, or stopping a current job and restarting it with modified parameters. These approaches waste compute resources, increase latency, and disrupt creative exploration. They also fail to preserve the exact mid-flight generation state from which the user wished to branch.

Interactive stories, branching playback systems, and conventional version histories may allow preauthored branches or completed output versions. However, they do not adequately address non-blocking duplication of live generative state during active AI media generation so that a parent trajectory continues while one or more child trajectories explore modified prompts or parameters.

Accordingly, there is a need for robust techniques that allow a running generative media pipeline to be forked mid-flight into multiple candidate outputs without halting the parent generation and without restarting each child generation from the beginning.

### SUMMARY

The present disclosure addresses these shortcomings with systems, methods, and computer program products for stateful branching and multi-variant generation in conversational media creation. In particular, the disclosed techniques allow a running generative media pipeline to be forked mid-flight into multiple candidate outputs without halting a parent generation process and without restarting each child generation from an initial state.

In one embodiment, a generative media system executes a parent generative trajectory for producing a video, image sequence, animation, effect, style transformation, or other media output. During execution, the system maintains a live generative state. The live generative state may include latent state, attention state, key-value cache state, diffusion state, render state, timeline state, frame state, scene graph state, effect parameter state, random seed state, scheduler state, or decoder state.

The system receives a branch instruction during execution. The branch instruction may originate from a conversational AI assistant, user interface selection, voice command, gesture, automated agent, policy engine, or predicted user preference. The branch instruction may identify a fork point and one or more modified prompts or parameters.

Without halting the parent trajectory, the system duplicates, references, snapshots, copy-on-writes, or otherwise derives a child generative state from the live generative state. The parent trajectory continues using the live generative state. A child trajectory executes using the child generative state and modified prompt or parameter set. Multiple child trajectories may be spawned from the same live generative state.

The system stores branch metadata linking the parent and child trajectories. The metadata may include fork point, inherited state identifier, modified parameters, source prompt, model identifier, tool identifier, user identifier, timeline location, branch status, output preview, utility score, and selection state. The branches may be represented in a project lineage graph and presented as selectable candidate outputs.

In some embodiments, the system performs shared-state multi-variant generation. Common state before the fork point may be shared among branches, while branch-specific suffix state is generated separately. Shared state may reduce memory usage, bandwidth, compute time, and latency relative to restarting each variant from the beginning.

Many other variations are possible.

### BRIEF DESCRIPTION OF FIGURES

The present disclosure will be understood more fully from the detailed description given below and from the accompanying drawings of various embodiments of the disclosure.

FIG. 1 illustrates a generative media pipeline maintaining live generative state during parent trajectory execution, according to an embodiment.

FIG. 2 illustrates receipt of a branch instruction during active generation, according to an embodiment.

FIG. 3 illustrates non-blocking creation of child generative states from a live parent state while the parent trajectory continues, according to an embodiment.

FIG. 4 illustrates a shared-prefix and branch-specific suffix architecture for multiple media generation trajectories, according to an embodiment.

FIG. 5 illustrates a media project lineage graph including parent and child trajectories, according to an embodiment.

FIG. 6 illustrates conversational selection, comparison, merge, or export of generated branches, according to an embodiment.

FIG. 7 illustrates local/cloud execution of parent and child trajectories across heterogeneous compute resources, according to an embodiment.

FIG. 8 illustrates a computing environment for implementing stateful branching and multi-variant generation, according to an embodiment.

FIG. 9 illustrates an overall method for stateful branching and multi-variant generation in a generative media pipeline, according to an embodiment.

FIG. 10 illustrates a method for fork-safe capture of live generative state and non-blocking branch creation, according to an embodiment.

FIG. 11 illustrates a method for shared-state multi-variant generation using shared-prefix state and branch-specific suffix state, according to an embodiment.

FIG. 12 illustrates an alternative or additional method for dynamic memory remapping and copy-on-write branch-state management, according to an embodiment.

FIG. 13 illustrates a method for conversational selection, comparison, merge, and export of generated branches, according to an embodiment.

### DETAILED DESCRIPTION

The following description provides systems, methods, and computer program products for allowing a running generative media pipeline to be forked mid-flight into multiple candidate outputs without halting the parent generation and without restarting each child generation from the beginning. The described embodiments are illustrative and not limiting. Features described with respect to one embodiment may be combined with features of other embodiments unless context indicates otherwise. Like reference numerals may refer to like or functionally related elements throughout the drawings.

### I. Systems for Generative Media Pipeline

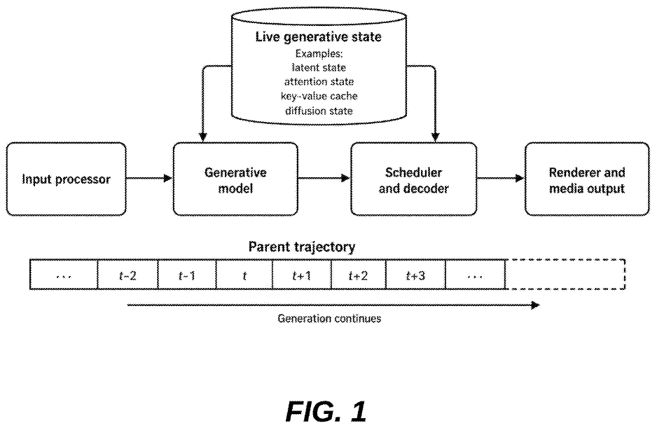

As in FIG. 1, a generative media system may include an input processor, a generative model, a scheduler, a decoder, a renderer, a media editor interface, a branch manager, a memory manager, a lineage graph manager, a conversational assistant interface, and a user interface. The generative media system may execute on a local device, edge device, cloud service, media editing workstation, mobile device, browser runtime, rendering service, AI accelerator cluster, or distributed combination thereof.

The input processor may receive a source prompt, source media asset, editing timeline, style instruction, reference image, audio track, caption track, mask, scene graph, object constraint, user preference, platform export target, or other input. The source media asset may include a video clip, image, audio recording, generated asset, animation, avatar state, three-dimensional scene, augmented reality object, virtual reality scene, or other temporally evolving media asset.

The generative model may include a diffusion model, transformer model, video generation model, image generation model, multimodal model, audio model, animation model, avatar model, style-transfer model, neural rendering model, scene-generation model, or a combination thereof. The generative model may execute a parent media trajectory to generate or transform media. The parent media trajectory may include a sequence of inference steps, diffusion steps, denoising steps, frame-generation steps, token-generation steps, render steps, decoder steps, scheduler steps, effect-processing steps, or timeline operations.

The renderer may produce an output video, image sequence, animation, effect, style transformation, avatar sequence, simulation output, augmented-reality scene, virtual-reality scene, or other temporally evolving media output. The renderer may generate a preview output, low-resolution proxy output, high-quality final output, branch-specific output, merged output, or platform-specific export output.

### A. Live Generative State

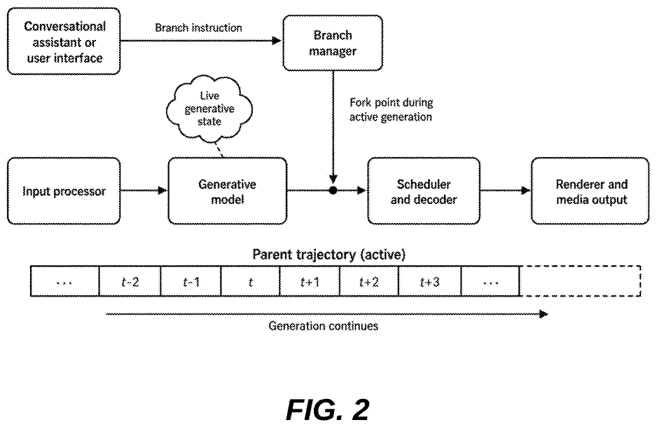

Also shown in FIG. 2, during execution of the parent media trajectory, the generative media system maintains a live generative state. The live generative state includes data sufficient to continue generation from a current execution point without restarting generation from the initial prompt or initial media asset.

The live generative state may include latent tensors, hidden states, attention state, key-value cache state, diffusion scheduler state, denoising state, noise state, seed state, conditioning state, frame buffers, optical-flow state, motion-vector state, object-tracking state, scene graph state, timeline state, render buffers, decoder state, effect parameters, output history, branch status, or execution-context metadata.

The live generative state may be stored in accelerator memory, high-bandwidth memory, graphics memory, unified memory, main memory, persistent storage, project state storage, remote object storage, cache memory, or a state store associated with a media editing tool. In some embodiments, a live generative state manager monitors live state during active generation and exposes selected state information to a branch manager, scheduler, user interface, media editor interface, or conversational assistant interface.

The live generative state may be associated with one or more fork points. A fork point may correspond to a time, frame index, diffusion step, token position, scene boundary, timeline marker, effect node, keyframe, decoder boundary, render boundary, tensor-operation boundary, user-selected preview point, or model-internal state. A fork point may be identified by the system, selected by a user, inferred from a conversational instruction, or generated by a policy or prediction engine.

### B. Non-Blocking Branch Manager

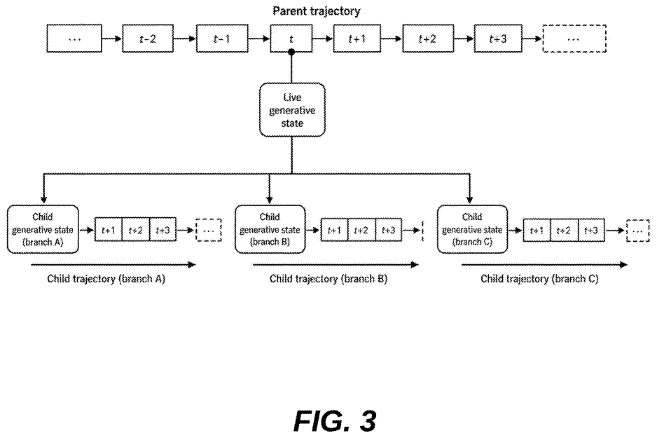

Referring to FIG. 3, the non-blocking branch manager may create one or more child generative states from a live generative state of an actively executing parent media trajectory while the parent media trajectory continues execution. In the illustrated embodiment, the parent media trajectory progresses through successive temporal, token, frame, diffusion, render, or model-execution positions, and a fork point is associated with the live generative state. The branch manager and memory manager derive a plurality of child generative states from the live generative state, such as child generative states for branch A, branch B, and branch C, without terminating, flushing, or restarting the parent trajectory. Each child trajectory may then continue from the fork point using a corresponding child generative state and a different modified prompt, parameter set, style instruction, rendering policy, model configuration, or media-editing instruction. In this manner, the system supports concurrent, asynchronous, or selectively scheduled exploration of multiple candidate outputs from a common in-flight generation state while preserving continuity of the parent trajectory.

In FIG. 2, Referring to FIG. 2, the branch manager receives a branch instruction while the parent media trajectory is actively executing and while the generative media system maintains the live generative state. The branch instruction may originate from a conversational artificial intelligence assistant, user interface selection, voice command, gesture, automated creative agent, media editor, policy engine, predicted user preference, or remote rendering service. The branch instruction may identify, or cause the branch manager to determine, a fork point within the active parent media trajectory, such as a time, frame index, diffusion step, token position, scene boundary, timeline marker, effect node, keyframe, tensor-operation boundary, render boundary, or model-internal state. In some embodiments, the branch instruction further includes, references, or causes retrieval of a modified prompt or parameter set for one or more prospective child trajectories. The fork point may be associated with the live generative state so that the system can subsequently derive one or more child generative states from the live generative state without stopping generation of the parent media trajectory.

The modified prompt or parameter set may modify style, aspect ratio, pacing, caption style, color grade, music, camera motion, lighting, background, duration, object identity, character pose, voice, animation behavior, platform format, model configuration, effect setting, or rendering policy.

In response to the branch instruction, the branch manager cooperates with the memory manager to derive one or more child generative states from the live generative state without halting continued execution of the parent media trajectory. The child generative state may be derived by snapshotting, copying, referencing, checkpointing, compressing, copy-on-writing, or creating a state delta for at least a portion of the live generative state.

The parent media trajectory continues using the live generative state. One or more child media trajectories execute using corresponding child generative states and corresponding modified prompts or parameter sets. The child media trajectories may execute in parallel, asynchronously, at a different priority, at a different quality level, at a different resolution, on a different processor, on a different accelerator, or in a different tool environment.

In some embodiments, the system creates multiple child trajectories from a common live generative state. For example, a parent video may continue in its original style while child trajectories generate cinematic, animated, corporate, humorous, short-form, long-form, vertical, square, or platform-specific variants. The system may rank, pause, discard, merge, export, or continue selected child trajectories.

### C. Shared-Prefix and Branch-Specific Suffix State

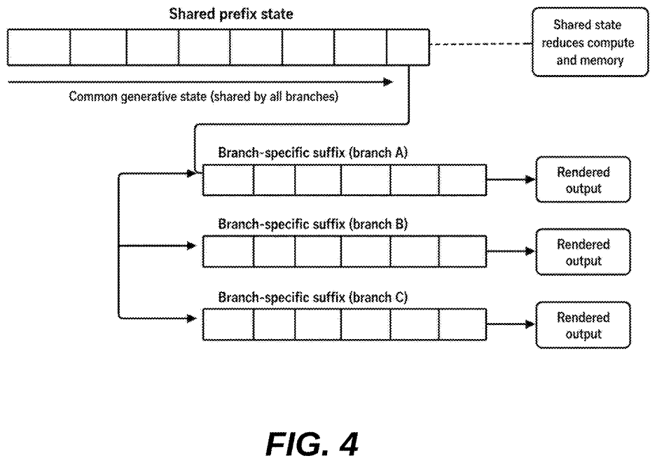

Referring to FIG. 4, a shared-prefix and branch-specific suffix architecture is illustrated for maintaining multiple media generation trajectories without requiring complete duplication of live generative state for each trajectory. A parent media trajectory and one or more child media trajectories may inherit a common shared-prefix state up to a fork point, while each child trajectory maintains a corresponding branch-specific suffix state generated after the fork point. The shared-prefix state may include common prompt context, conditioning state, latent state, attention state, render state, timeline state, scene graph state, frame history, key-value cache state, or other reusable generative state. The branch-specific suffix state may include modified prompt state, modified conditioning state, branch-specific latent state, branch-specific attention state, branch-specific diffusion state, branch-specific render buffers, branch-specific effect parameters, branch-specific timeline edits, or branch-specific output history. By separating shared-prefix state from branch-specific suffix state, the system can generate, transfer, reconstruct, replay, validate, continue, compare, or merge multiple candidate media trajectories while reducing memory usage, bandwidth usage, storage cost, accelerator time, and recomputation latency.

In some embodiments, the memory manager maintains a shared-prefix state and one or more branch-specific suffix states for the parent media trajectory and child media trajectories. The shared-prefix state may include common prompt context, common conditioning state, common latent state, common frame history, common attention state, common key-value cache state, common render state, common scene graph state, common timeline state, common retrieval results, common model state, or other reusable inference state that is inherited by multiple trajectories before divergence.

Each branch-specific suffix state may include state generated after a fork point. The branch-specific suffix state may include modified prompt state, modified conditioning state, modified latent state, branch-specific attention state, branch-specific diffusion state, branch-specific key-value cache state, branch-specific render buffers, branch-specific effect parameters, branch-specific timeline edits, branch-specific output history, or branch-specific media editor state.

By maintaining shared-prefix state separately from branch-specific suffix state, the system may generate multiple candidate media trajectories without duplicating the entire live generative state for each candidate trajectory. This architecture may reduce memory usage, bandwidth usage, accelerator time, storage cost, and recomputation latency relative to independently restarting each candidate media generation.

In some embodiments, the memory manager forms a branch-consistent state package. The branch-consistent state package preserves an association between a shared-prefix state and a corresponding branch-specific suffix state so that a selected parent trajectory or child trajectory can be transferred, reconstructed, referenced, replayed, validated, or continued across a different compute tier or tool environment without full recomputation of the shared-prefix state.

A branch-consistent state package may include a shared-prefix identifier, branch identifier, fork point identifier, state pointer, state delta, branch-specific suffix descriptor, model identifier, tool identifier, execution tier identifier, version identifier, rights metadata, lineage metadata, and reconstruction instructions. The branch-consistent state package may be serialized, compressed, encrypted, transmitted, stored in a project file, or mapped to a media editing tool state.

### D. Dynamic Memory Remapping and Copy-on-Write Branch Storage

In some embodiments, the live generative state, shared-prefix state, or branch-specific suffix state is stored using a dynamically remapped physical memory layout. A memory controller or memory manager may determine that portions of a latent representation, residual representation, frame-state tensor, attention state, key-value cache state, render state, or other generative state are unchanged, zeroed, masked, low-variance, correlated, reconstructible, aliased, or shared across multiple trajectories.

Based on that determination, the memory controller or memory manager may compact, alias, merge, migrate, release, checkpoint, compress, reconstruct on demand, or copy-on-write selected portions of physical storage while preserving a logical tensor view for the parent and child trajectories. The downstream generative model, decoder, renderer, or media editing tool may therefore operate as if a complete branch state is present, even though physical storage is shared, compacted, compressed, aliased, or reconstructed.

In some embodiments, unchanged latent lanes or residual lanes are aliased across a parent trajectory and one or more child trajectories until a child trajectory writes divergent state. Responsive to divergent state being written, the memory manager may allocate branch-specific storage for the divergent portion while retaining shared or aliased storage for unchanged portions.

In some embodiments, low-priority or reconstructible portions of branch state are migrated to a lower memory tier, compressed, evicted, or reconstructed on demand based on memory pressure, bandwidth pressure, predicted reuse, quality-of-service requirements, thermal conditions, branch priority, expected user-selection probability, or rendering deadline. Dynamic memory remapping may thereby reduce memory pressure, bandwidth consumption, cache pressure, storage cost, and recomputation overhead during multi-variant generation.

### E. Multi-Configuration Scheduling Across Parent and Child Trajectories

In some embodiments, the scheduler applies a multi-configuration scheduling technique in which multiple candidate media variants are executed as interleaved configurations within a shared hardware execution context. A first trajectory may use a first prompt, style setting, aspect ratio, model configuration, effect setting, or rendering policy, while one or more child trajectories use modified prompts, style settings, aspect ratios, model configurations, effect settings, or rendering policies.

The scheduler may interleave execution of parent and child trajectories across one or more shared accelerator resources while maintaining live generative state for each trajectory. The scheduler may allocate execution based on branch priority, predicted selection probability, compute cost, memory cost, user attention, preview need, output deadline, quality target, accelerator availability, thermal state, power budget, or platform export target.

In some embodiments, the scheduler executes the parent trajectory on a local device for low-latency preview and executes one or more child trajectories on a cloud accelerator, graphics processing unit cluster, neural processing unit, rendering service, or distributed media generation service. In other embodiments, a parent trajectory executes in the cloud while one or more child branches are previewed locally using compressed, proxy, or lower-resolution states.

The scheduler may pause, demote, migrate, terminate, compress, or discard low-value branches. The scheduler may also promote a selected branch to a higher-quality rendering path or continue a selected branch as a new parent trajectory.

### F. Media Project Lineage Graph

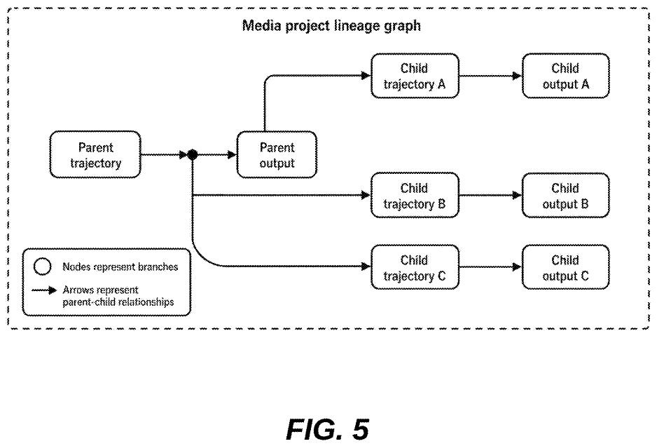

In FIG. 5, a lineage graph manager stores branch metadata linking parent and child media trajectories. The lineage graph may represent relationships among prompts, fork points, live generative states, shared-prefix states, branch-specific suffix states, model versions, tool versions, generated previews, rendered outputs, user selections, merges, exports, and discarded branches.

Each node in the lineage graph may correspond to a parent trajectory, child trajectory, fork point, project state, timeline state, render state, preview output, final output, branch-specific suffix state, or merged composite output. Each edge may represent derivation, inheritance, transformation, continuation, selection, merge, export, discard, or rollback.

The lineage graph may be used for user navigation, branch comparison, merge, rollback, provenance, export, rights evaluation, cache eviction, memory compaction, or garbage collection. The lineage graph may also preserve shared state references so that storage and compute are not duplicated unnecessarily across multiple candidate outputs.

In some embodiments, a merged output may inherit lineage from multiple branches. For example, a first child branch may provide a preferred opening, a second child branch may provide a preferred color grade, and a third child branch may provide a preferred ending. The system may merge selected portions into a composite media trajectory while retaining metadata identifying the source branches and source fork points for the composite output.

### G. Conversational Selection, Comparison, Merge, and Export Interface

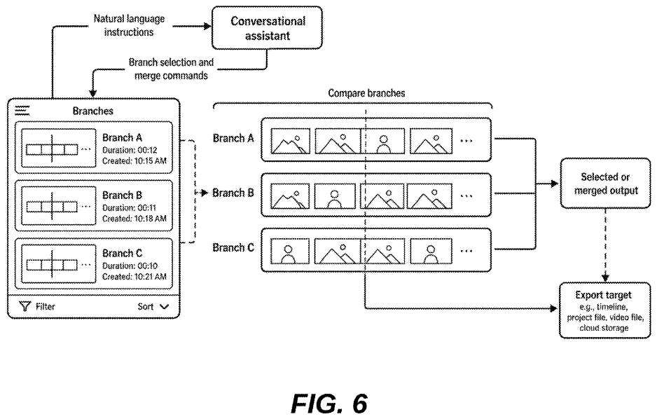

In FIG. 6, the conversational assistant interface may receive natural language instructions associated with branch creation, selection, comparison, merge, continuation, discard, or export. Example instructions include “try a warmer version from here,” “make three endings,” “show one version with faster pacing,” “change the background after this point,” “merge the opening from branch A with the ending from branch C,” or “export the professional version for LinkedIn and the vertical version for short-form video.”

The user interface may present selectable candidate outputs, branch previews, thumbnails, timelines, quality scores, style labels, rendering status, duration indicators, estimated cost, rights status, branch metadata, or lineage relationships. A user may select, compare, continue, discard, merge, or export one or more candidate media trajectories through natural language, voice input, gesture input, cursor selection, gaze input, touch input, editor command, or automated agent instruction.

In some embodiments, the conversational assistant interface updates branch instructions based on user selections, user rejection, hover behavior, dwell time, replay behavior, manual edits, cursor scrubbing, or voice feedback. The system may continue generation from a selected branch, generate additional child branches from the selected branch, merge selected branch portions, or export selected branches to a media editor, project file, video file, cloud storage location, social platform, enterprise repository, or publishing service.

### H. Heterogeneous and Cross-Tool Execution

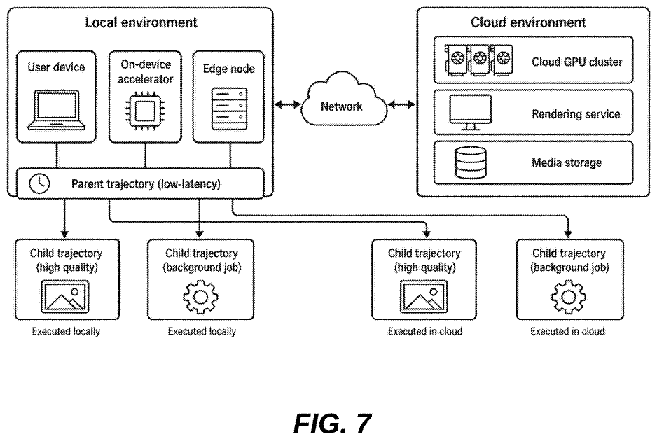

FIG. 7 illustrates the parent and child trajectories may be executed across different compute tiers or tool environments. A parent trajectory may remain on a local user device for low-latency preview while a child trajectory is promoted to a cloud graphics processing unit, neural processing unit, tensor processor, media rendering service, or distributed accelerator cluster for high-quality rendering. A child trajectory may be transferred to a specialized media editor, effects engine, captioning engine, audio generator, avatar generator, rendering service, or publishing service.

Shared state may be serialized, compressed, encrypted, or converted to a tool-compatible representation during transfer. The branch-consistent state package may allow a receiving environment to continue a trajectory without full recomputation of the shared-prefix state. The receiving environment may reconstruct, reference, replay, validate, or continue the selected trajectory using the transferred state package.

In some embodiments, rights metadata, provenance metadata, platform constraints, export requirements, or user permissions travel with the branch-consistent state package. Accordingly, a child trajectory may be continued or rendered in a remote environment while preserving lineage and policy information associated with the parent trajectory.

### I. Computing Environment

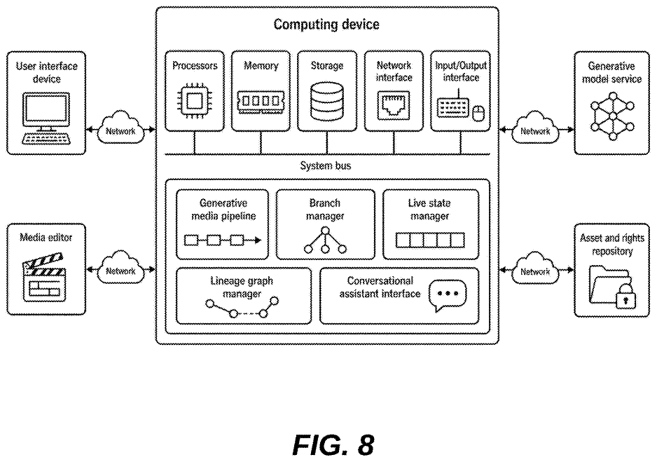

FIG. 8 shows the disclosed systems may execute on one or more computing devices including processors, graphics processing units, neural processing units, tensor processing units, media encoders, digital signal processors, mobile processors, edge processors, cloud servers, browser runtimes, media workstations, or distributed systems. Memory may include RAM, VRAM, unified memory, high-bandwidth memory, cache memory, persistent storage, object storage, project files, state stores, databases, or network-accessible storage.

The generative media pipeline, branch manager, memory manager, scheduler, renderer, media editor interface, lineage graph manager, conversational assistant interface, and user interface may execute on the same device or across multiple devices connected by a network. Communications may occur through local APIs, media editing APIs, model serving APIs, streaming protocols, project-file formats, cloud storage interfaces, or other communication mechanisms.

The disclosed systems may be implemented as software, firmware, hardware, middleware, a media editor plug-in, browser extension, cloud service, operating system service, AI assistant service, rendering service, or a combination thereof.

### II. Methods for Generative Media Pipeline

### A. Overall Stateful Branching Process

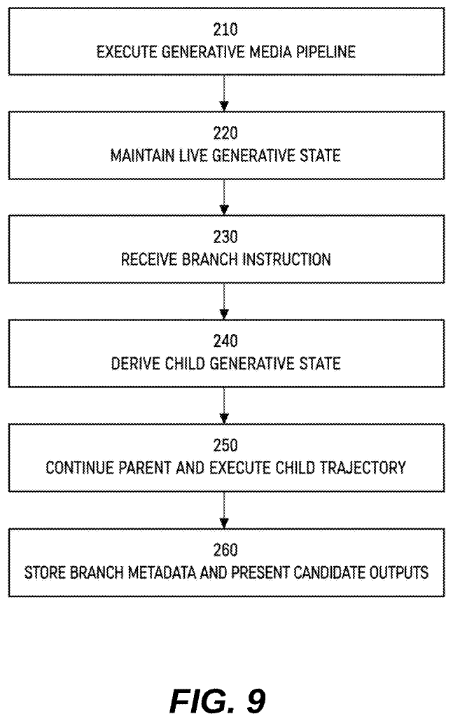

FIG. 9 illustrates an overall method for stateful branching and multi-variant generation in a generative media pipeline, according to an embodiment.

At step 210, a generative media pipeline is executed to produce a parent media trajectory for a temporally evolving media output, such as a video, image sequence, animation, effect, style transformation, avatar, simulation, augmented-reality scene, or other generated media output. The parent media trajectory may be produced by a diffusion model, transformer model, video model, multimodal model, audio model, animation model, neural renderer, or a combination thereof.

At step 220, live generative state is maintained during execution of the parent media trajectory. The live generative state may include latent state, attention state, key-value cache state, diffusion state, render state, timeline state, frame state, scene graph state, effect-parameter state, scheduler state, decoder state, noise state, seed state, conditioning state, optical-flow state, object-tracking state, or output-history state.

At step 230, a branch instruction is received during active generation. The branch instruction may identify a fork point and a modified prompt or parameter set. The branch instruction may originate from a conversational artificial intelligence assistant, user interface selection, voice command, gesture, automated agent, policy engine, predicted user preference, media editor, or remote rendering service.

At step 240, a child generative state is derived from the live generative state without halting continued execution of the parent media trajectory. The child generative state may be derived by snapshotting, copying, referencing, checkpointing, compressing, copy-on-writing, or creating a state delta for at least a portion of the live generative state.

At step 250, the parent media trajectory continues using the live generative state while one or more child media trajectories execute using corresponding child generative states and modified prompts or parameters. In some embodiments, a plurality of child media trajectories are generated from the same live generative state using different modified prompts or parameter sets.

At step 260, branch metadata is stored and the parent and child media trajectories are presented as selectable candidate outputs. The branch metadata may identify a fork point, parent branch, child branch, inherited state, modified parameter set, model identifier, tool identifier, execution location, render status, preview, quality score, rights status, selection state, or lineage relationship.

### B. Fork-Safe State Capture and Non-Blocking Branch Creation

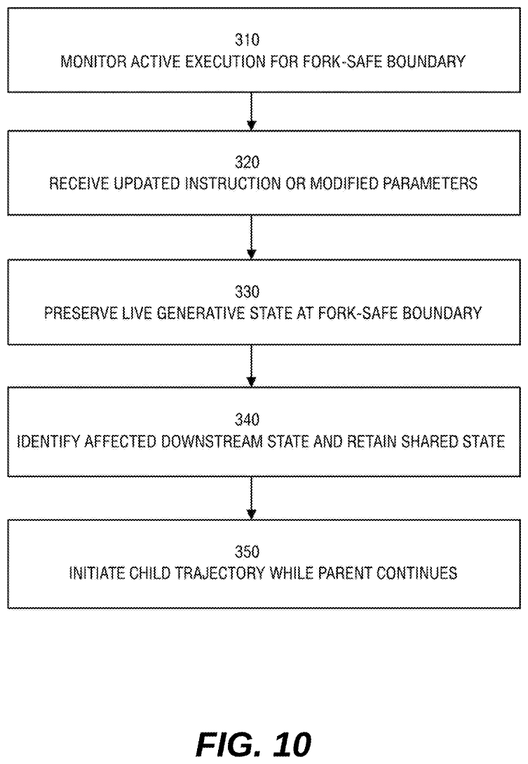

FIG. 10 illustrates a method for fork-safe capture of live generative state and non-blocking branch creation, according to an embodiment.

At step 310, an active execution point of the generative media pipeline is monitored to identify a fork-safe boundary. The fork-safe boundary may correspond to a time, frame index, diffusion step, token position, scene boundary, timeline marker, effect node, keyframe, tensor-operation boundary, decoder boundary, render boundary, or model-internal state.

At step 320, an updated instruction or modified parameter set is received before completion of the parent media trajectory. The updated instruction or modified parameter set may request a different style, aspect ratio, pacing, caption style, color grade, music, camera motion, lighting, background, duration, object identity, platform format, model configuration, or rendering policy.

At step 330, the live generative state is preserved at the fork-safe boundary. Preserving the live generative state may include storing spatial-temporal model state, latent tensors, attention state, frame-state tensors, render buffers, scheduler state, decoder state, key-value cache state, or execution-context metadata.

At step 340, downstream state portions affected by the modified prompt or parameter set are identified. In some embodiments, unaffected upstream or shared state portions are retained, while downstream portions depending on a changed conditioning context are selectively invalidated, recomputed, or replaced.

At step 350, a child trajectory is initiated from the preserved live generative state while the parent trajectory continues. The child trajectory may execute in parallel, asynchronously, at lower priority, at higher quality, on a different accelerator, or in a remote compute environment.

### C. Shared-Prefix and Branch-Specific Suffix Process

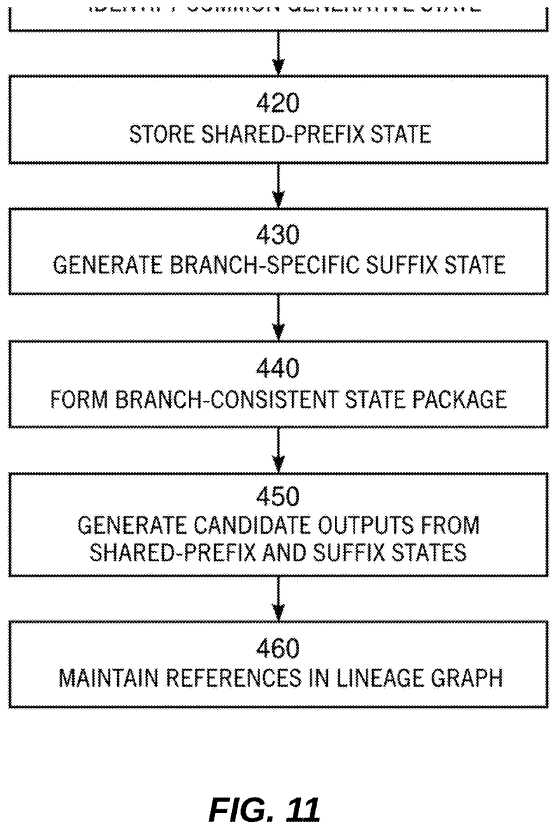

FIG. 11 illustrates a method for shared-state multi-variant generation using shared-prefix state and branch-specific suffix state, according to an embodiment.

At step 410, common generative state shared by multiple media trajectories is identified. The common generative state may include common prompt context, common conditioning state, common latent state, common frame history, common attention state, common render state, common scene graph state, common timeline state, common retrieval results, or common model state.

At step 420, the common generative state is stored or referenced as a shared-prefix state. The shared-prefix state may be maintained in accelerator memory, unified memory, high-bandwidth memory, cloud memory, a project state store, or another memory tier accessible to the parent trajectory and one or more child trajectories.

At step 430, a branch-specific suffix state is generated for each child trajectory after a fork point. The branch-specific suffix state may include modified prompt state, modified conditioning state, modified latent state, branch-specific attention state, branch-specific diffusion state, branch-specific render buffers, branch-specific effect parameters, branch-specific timeline edits, or branch-specific output history.

At step 440, a branch-consistent state package is formed for a selected trajectory. The branch-consistent state package may preserve an association between the shared-prefix state and a corresponding branch-specific suffix state so that the selected trajectory can be transferred, reconstructed, referenced, replayed, validated, or continued without full recomputation of the shared-prefix state.

At step 450, candidate media outputs are rendered or generated based on the shared-prefix state and corresponding branch-specific suffix states. Multiple variants may thereby be produced while reducing memory use, bandwidth use, compute time, and latency relative to restarting each variant from an initial state.

At step 460, references between the shared-prefix state, branch-specific suffix states, and rendered outputs are maintained in a lineage graph. The lineage graph may support user navigation, branch comparison, merge, rollback, provenance, export, garbage collection, or rights evaluation.

### D. Dynamic Memory Remapping and Copy-on-Write Branch State

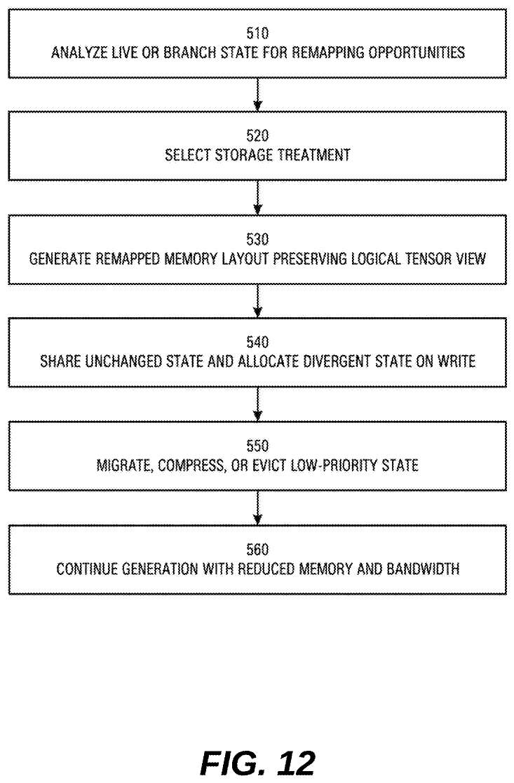

FIG. 12 illustrates an alternative or additional method for dynamic memory remapping and copy-on-write branch-state management, according to an embodiment.

At step 510, portions of live generative state or branch-specific state are analyzed to determine whether they are unchanged, zeroed, masked, low-variance, correlated, reconstructible, aliased, or shared across multiple trajectories. The analyzed state may include latent representations, residual representations, frame-state tensors, attention state, render state, or other generative state.

At step 520, a physical storage treatment is selected for one or more portions of the analyzed state. The selected treatment may include compacting, aliasing, merging, migrating, releasing, checkpointing, compressing, reconstructing on demand, or applying copy-on-write behavior.

At step 530, a remapped memory layout is generated while preserving a logical tensor view for downstream model layers, render operations, or media editing tools. In this manner, parent and child trajectories may appear to have complete generative state even though physical storage is shared, compressed, aliased, or otherwise remapped.

At step 540, unchanged portions of branch state are shared or aliased across parent and child trajectories until a child trajectory writes divergent state. Responsive to divergence, a branch-specific physical storage region may be allocated or updated for the divergent portion.

At step 550, low-priority or reconstructible portions of branch state may be migrated to a lower memory tier, compressed, evicted, or reconstructed on demand based on memory pressure, bandwidth pressure, predicted reuse, quality-of-service requirements, thermal conditions, or branch priority.

At step 560, the remapped state is used to continue generation of parent and child trajectories while reducing memory pressure, bandwidth consumption, cache pressure, storage cost, or recomputation overhead.

### E. Conversational Selection, Merge, and Export

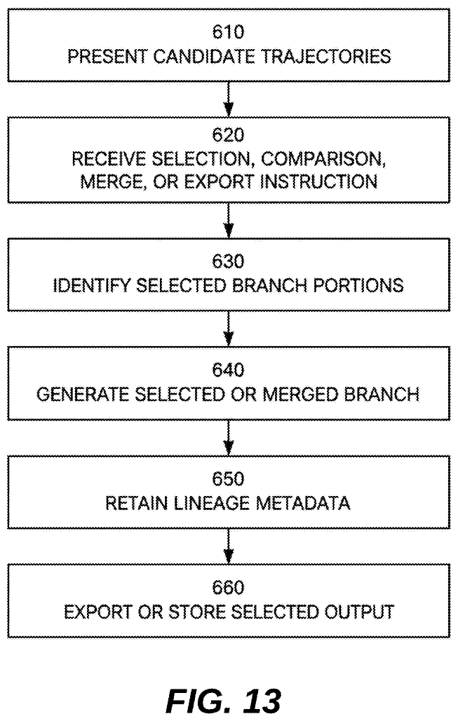

FIG. 13 illustrates a method for conversational selection, comparison, merge, and export of generated branches, according to an embodiment.

At step 610, a conversational artificial intelligence assistant or user interface presents a plurality of candidate media trajectories generated from a common live generative state. The candidate media trajectories may include previews, thumbnails, timeline regions, quality scores, cost estimates, style labels, duration indicators, rights status, or branch metadata.

At step 620, a user instruction is received to select, compare, continue, discard, merge, or export one or more candidate media trajectories. The user instruction may be received as natural language, voice input, gesture input, cursor selection, gaze input, touch input, editor command, or automated agent instruction.

At step 630, one or more selected portions of one or more branches are identified. For example, a first branch may provide a preferred opening, a second branch may provide a preferred color grade, and a third branch may provide a preferred ending.

At step 640, a selected branch or merged composite branch is generated. The selected branch or merged composite branch may be continued as a new parent trajectory, rendered as a candidate output, exported to a media editor, or stored as a project version.

At step 650, lineage metadata is retained for the selected or merged output. The lineage metadata may identify parent branches, child branches, source prompts, modified parameter sets, fork points, shared-prefix state, branch-specific suffix state, media tools, model identifiers, render locations, user selections, and export targets.

Many other embodiments are possible.

I claim:

1. A computer-implemented method comprising:
executing, by one or more processors, a generative media pipeline to produce a parent media trajectory for a temporally evolving media output;
maintaining, during execution of the generative media pipeline, a live generative state sufficient to continue generation of the parent media trajectory from a current execution point;
receiving, during the execution of the generative media pipeline, a branch instruction identifying a fork point and a modified prompt or parameter set;
deriving a child generative state from the live generative state without halting continued execution of the parent media trajectory;
continuing execution of the parent media trajectory using the live generative state;
executing a child media trajectory using the child generative state and the modified prompt or parameter set;
storing branch metadata linking the parent media trajectory and the child media trajectory; and
presenting the parent media trajectory and the child media trajectory as selectable candidate outputs.

2. The method of claim 1, wherein the live generative state comprises at least one of latent state, attention state, key-value cache state, diffusion state, render state, timeline state, frame state, scene graph state, effect-parameter state, scheduler state, decoder state, noise state, seed state, optical-flow state, object-tracking state, or output-history state.

3. The method of claim 1, wherein the fork point comprises at least one of a time, frame index, diffusion step, token position, scene boundary, timeline marker, user-selected preview point, effect node, keyframe, tensor-operation boundary, or model-internal state.

4. The method of claim 1, wherein deriving the child generative state comprises snapshotting, copying, referencing, checkpointing, compressing, copy-on-writing, or creating a state delta for at least a portion of the live generative state.

5. The method of claim 1, wherein the modified prompt or parameter set modifies at least one of style, aspect ratio, pacing, caption style, color grade, music, camera motion, lighting, background, duration, object identity, platform format, model configuration, or rendering policy.

6. The method of claim 1, further comprising generating a plurality of child media trajectories from the live generative state using different modified prompts or parameter sets while the parent media trajectory continues execution.

7. The method of claim 1, further comprising maintaining a shared-prefix state inherited by the parent media trajectory and the child media trajectory and maintaining a branch-specific suffix state for the child media trajectory.

8. The method of claim 7, wherein the shared-prefix state comprises at least one of common prompt context, common conditioning state, common latent state, common frame history, common attention state, common render state, common scene graph state, common timeline state, common retrieval results, or common model state.

9. The method of claim 7, wherein the branch-specific suffix state comprises state generated after the fork point, including at least one of modified prompt state, modified conditioning state, modified latent state, branch-specific attention state, branch-specific diffusion state, branch-specific render buffers, branch-specific effect parameters, branch-specific timeline edits, or branch-specific output history.

10. The method of claim 1, further comprising forming a branch-consistent state package that preserves an association between a shared-prefix state and a branch-specific suffix state for transfer, reconstruction, reference, replay, validation, or continuation of the child media trajectory across a different compute tier or tool environment.

11. The method of claim 1, further comprising storing the branch metadata in a media project lineage graph representing a parent-child relationship between the parent media trajectory and the child media trajectory.

12. The method of claim 11, further comprising merging a first portion of the child media trajectory with a second portion of another media trajectory to generate a composite media trajectory while retaining lineage metadata identifying source branches for the composite media trajectory.

13. The method of claim 1, wherein the branch instruction is generated by a conversational artificial intelligence assistant based on a natural language instruction received during active generation of the parent media trajectory.

14. The method of claim 1, further comprising executing the parent media trajectory on a local device and executing the child media trajectory on a remote cloud accelerator or rendering service.

15. The method of claim 1, further comprising dynamically remapping physical memory used to store the live generative state, the child generative state, a shared-prefix state, or a branch-specific suffix state by compacting, aliasing, merging, migrating, releasing, checkpointing, compressing, or copy-on-writing selected portions of storage while preserving a logical tensor view for downstream generation.

16. The method of claim 15, wherein dynamically remapping physical memory is based on detecting that portions of the live generative state are unchanged, zeroed, masked, low-variance, correlated, reconstructible, aliased, or shared across multiple media trajectories.

17. A system comprising:
one or more processors;
memory coupled to the one or more processors;
a generative media pipeline configured to generate a parent media trajectory for a temporally evolving media output;
a branch manager configured to receive, during active generation of the parent media trajectory, a branch instruction identifying a fork point and a modified prompt or parameter set;
a memory manager configured to derive a child generative state from live generative state of the parent media trajectory without halting the parent media trajectory;
a scheduler configured to continue the parent media trajectory and execute a child media trajectory using the child generative state; and
a lineage graph manager configured to store branch metadata linking the parent media trajectory and the child media trajectory.

18. The system of claim 17, wherein the memory manager is further configured to maintain a shared-prefix state and branch-specific suffix states for a plurality of media trajectories generated from the live generative state.

19. The system of claim 17, wherein the scheduler is configured to interleave execution of a plurality of candidate media variants within a shared hardware execution context while maintaining live generative state for each candidate media variant.

20. A non-transitory computer-readable medium storing instructions that, when executed by one or more processors, cause the one or more processors to:
execute a generative media pipeline to produce a parent media trajectory;
maintain live generative state during execution of the parent media trajectory;
receive, during execution, a branch instruction identifying a fork point and a modified prompt or parameter set;
derive a child generative state from the live generative state without halting the parent media trajectory; continue the parent media trajectory;
execute a child media trajectory using the child generative state and the modified prompt or parameter set;
store branch metadata linking the parent media trajectory and the child media trajectory in a media project lineage graph; and
present the parent media trajectory and child media trajectory as selectable candidate outputs.
